(19) United States
(12) Patent Application Publication
(10) Pub. No.: US 2020/0358764 A1
(43) Pub. Date: Nov. 12, 2020

(54) SYSTEM AND METHOD FOR GENERATING SYMMETRIC KEY TO IMPLEMENT MEDIA ACCESS CONTROL SECURITY CHECK

(71) Applicant: Verizon Patent and Licensing Inc., Arlington, VA (US)

(72) Inventors: Warren HOJILLA UY, Randolph, NJ (US); Manuel Enrique CACERES, Basking Ridge, NJ (US); Taussif KHAN, Martinsville, NJ (US); Young Rak CHOI, Belle Mead, NJ (US)

(21) Appl. No.: 16/405,829

(22) Filed: May 7, 2019

(51) Int. Cl. H04L 29/06; H04L 9/32

(52) U.S. Cl. CPC H04L 63/0876; H04L 63/0823; H04L 9/3236; H04L 63/0435; H04L 63/061

(57) ABSTRACT

A first device may transmit, to a peer device, a first digital certificate containing a first unique identifier associated with the first device and receive, from the peer device, a second digital certificate containing a second unique identifier associated with the peer device. The first device and the peer device may independently generate a symmetric key using a cryptographic hash function based on respectively determining that a certificate authority signed the first digital certificate and the second digital certificate. For example, the first device and the peer device may independently generate the symmetric key using the cryptographic hash function based on the first unique identifier, the second unique identifier, and one or more random numbers. Accordingly, the first device and the peer device may use the symmetric key to establish a secure communication session over an Ethernet link.

### BACKGROUND

Media Access Control security (MACsec) is a security standard, defined by the Institute of Electrical and Electronics Engineers (IEEE) 802.1AE, that defines connectionless data confidentiality and integrity for media access independent protocols. The MACsec standard specifies a set of protocols to meet security requirements for protecting data traversing Ethernet local area networks (LANs). MACsec allows unauthorized LAN connections to be identified and excluded from communication within the network, and defines a security infrastructure to provide data confidentiality, data integrity, data origin authentication, and/or the like.

### BRIEF DESCRIPTION OF THE DRAWINGS

FIGS. 1A-1D are diagrams of one or more example implementations described herein.

FIG. 2 is a diagram of an example environment in which systems and/or methods described herein may be implemented.

FIG. 3 is a diagram of example components of one or more devices of FIG. 2.

FIG. 4 is a flow chart of an example process for generating a symmetric key to implement a Media Access Control security (MACsec) check.

### DETAILED DESCRIPTION OF PREFERRED EMBODIMENTS

The following detailed description of example implementations refers to the accompanying drawings. The same reference numbers in different drawings can identify the same or similar elements.

Media Access Control security (MACsec), defined by the Institute of Electrical and Electronics Engineers (IEEE) 802.1AE, is a security standard that enables secure communication for traffic on Ethernet links. MACsec generally provides point-to-point security on an Ethernet link between a pair of directly connected nodes (e.g., a router-to-router link, a switch-to-router link, a switch-to-host link, and/or the like) and can be used to identify and prevent various security threats, including denial of service, intrusion, man-in-the-middle, masquerading, passive wiretapping, playback attacks, and/or the like. For example, according to the MACsec standard, a point-to-point Ethernet link may be secured after matching security keys have been exchanged and verified between interfaces at each end of the point-to-point Ethernet link. Once MACsec has been enabled on the point-to-point Ethernet link, traffic traversing the Ethernet link is secured through data integrity checks and/or encryption. Accordingly, MACsec can be used to secure Ethernet traffic at the MAC layer, including frames associated with a Link Layer Discovery Protocol (LLDP), a Link Aggregation Control Protocol (LACP), a Dynamic Host Configuration Protocol (DHCP), an Address Resolution Protocol (ARP), and/or other protocols that may not otherwise be secured on an Ethernet link. Furthermore, MACsec can be used in combination with other security protocols such as IP Security (IPsec) and Secure Sockets Layer (SSL) to provide end-to-end network security.

To initially establish a secure point-to-point Ethernet link using MACsec, interfaces at each end of the point-to-point Ethernet link typically exchange a pre-shared key, which may include a connectivity association key name (CKN) and a connectivity association key (CAK) to secure control plane traffic. After each end of the point-to-point Ethernet link exchanges and verifies that the pre-shared key, the CKN, and the CAK match or are otherwise in agreement with each other, a MACsec Key Agreement (MKA) protocol may be enabled to maintain MACsec on the Ethernet link. For example, the MKA protocol may designate one of the endpoints to act as a key server, which is responsible for creating a randomly-generated secure association key (SAK) that secures data plane traffic. The endpoint acting as the key server may share the SAK with the other endpoint, and the SAK is used to secure data traffic that traverses the point-to-point Ethernet link. The key server may continue to periodically create and share a randomly-generated SAK over the point-to-point Ethernet link while MACsec is enabled.

One challenge that may arise when implementing MACsec is the need to provision a symmetric key (e.g., matching pre-shared keys) onto two Ethernet devices that will be connected via a point-to-point Ethernet link. For example, the symmetric key may be manually provisioned (e.g., preloaded at manufacture time, configured by a user, and/or the like) or dynamically provisioned as part of an Authentication, Authorization, and Accounting (AAA) handshake with a Remote Authentication Dial-In User Service (RADIUS) server that uses Extensible Authentication Protocol-Transport Layer Security (EAP-TLS) to support MACsec.

In the former case, manually provisioning the symmetric key creates challenges whereby Ethernet devices from different original equipment manufacturers (OEMs) may be unable to communicate using MACsec because different OEMs typically do not share information related to the symmetric key with one another. For example, because a symmetric key is a shared secret key, with both devices holding the same copy, OEMs often implement various key management policies to securely select, distribute, change, and store keys in order to prevent and/or limit the impact of a cryptographic attacker discovering the symmetric key(s). Accordingly, manually provisioning the symmetric key is not a feasible solution to enable MACsec between devices from different OEMs, because the symmetric key is known to only one OEM (i.e., devices that are manually provisioned with a symmetric key by a particular OEM could only use MACsec to communicate with other devices from the same OEM). For MACsec to work across multiple OEMs, another entity (e.g., a trusted third party) must coordinate with the multiple OEMS in order to manage generating, storing, distributing, exchanging, destroying, replacing, and/or otherwise managing the symmetric keys. This can lead to consumption of significant computing resources, including resources to deploy, configure, operate, and maintain key servers, cryptographic protocols, user procedures, and/or the like to enforce key management policies used to distribute symmetric keys in an authenticated and confidential manner.

Similarly, in scenarios where the symmetric key is dynamically provisioned using a AAA handshake with a RADIUS server, various resources (e.g., computing resources, network resources, financial resources, human resources, and/or the like) are consumed to deploy, configure, operate, and maintain the RADIUS server, handle network traffic that relates to the key provisioning, and/or the like. For example, to configure MACsec on an Ethernet link between a first device and a second device using dynamic key provisioning, the RADIUS server typically passes the symmetric key to the first device and to the second device in independent network transactions. The first device and the second device may then exchange the symmetric key as described above to create a MACsec-secured connection. Accordingly, dynamically provisioning the symmetric key introduces additional network overhead, since both devices need to communicate with the RADIUS server to obtain the symmetric key. Furthermore, as mentioned above, the RADIUS server may need to use EAP-TLS to support MACsec, which may be more resource intensive, complex, and/or the like relative to other authentication frameworks (e.g., password-only, MD5, and/or the like) that cannot be used to support MACsec.

Some implementations described herein may provide various techniques to enable Ethernet devices to self-generate a symmetric key that can be used to establish a MACsec-secured connection. More particularly, when a given pair of devices are connected via an Ethernet cable and powered on, the devices may perform a handshake procedure in which the devices exchange respective unique identifiers (e.g., an International Mobile Equipment Identity (IMEI), a media access control (MAC) address, a serial number, a universally unique identifier (UUID), and/or the like). For example, the devices may obtain respective digital certificates from a trusted certificate authority (CA) by communicating with the CA via Simple Certificate Enrollment Protocol (SCEP), over a REpresentational State Transfer (REST) application program interface provided by the CA, and/or the like. The digital certificate that the CA issues to a device may generally include one or more unique identifiers associated with the device, a public key owned by the device, a validity period for the digital certificate, and/or the like.

During the handshake procedure, the devices may exchange the respective digital certificates obtained from the CA, and each device may read, extract, or otherwise obtain the unique identifier of the other device from the digital certificate received from the other device. In some implementations, the unique identifier of the other device may be obtained after validating the digital certificate received from the other device (e.g., verifying that the CA signed the digital certificate, verifying that the digital certificate has not expired or been revoked, and/or the like). Accordingly, each device may generate the symmetric key based on its own unique identifier in combination with the unique identifier associated with the other device. Moreover, in some implementations, the symmetric key may be further based on one or more random numbers (e.g., a cryptographic salt) that are coordinated between the devices according to a suitable scheme in order to ensure further security of the symmetric key. After each device has self-generated the symmetric key, the devices may establish a MACsec-secured Ethernet connection using the symmetric key in a similar manner as described elsewhere herein.

In this way, devices that are associated with different manufacturers can perform the handshake procedure described herein to self-generate the symmetric key used to establish a MACsec-secured Ethernet connection. In this way, the symmetric key does not have to be pre-shared between the devices, which conserves computing resources, network resources, and/or the like that would otherwise be consumed by manually provisioning the devices with the symmetric key at manufacture time and/or dynamically provisioning the devices with the symmetric key using a RADIUS server. Furthermore, because the trusted CA is used to distribute the digital certificates that the devices use to authenticate one another prior to generating the symmetric key, security is improved because each digital signature signed by the trusted CA inherits a trustworthiness of a root certificate associated with the trusted CA. In this way, the trustworthiness of the digital certificates exchanged between the devices enables additional security measures, such as using public-key (or asymmetric) cryptography to securely coordinate the random number(s), cryptographic salt(s), and/or the like to be used when the symmetric key is generated. Additionally, or alternatively, one or more security measures may be implemented using one or more tamper detection mechanisms, such as a circuit, a device, and/or the like that can monitor electrical characteristics of the Ethernet cable connecting the devices and alert the endpoint devices to renegotiate the symmetric key based on the monitored electrical characteristics indicating potential tampering with the Ethernet cable.

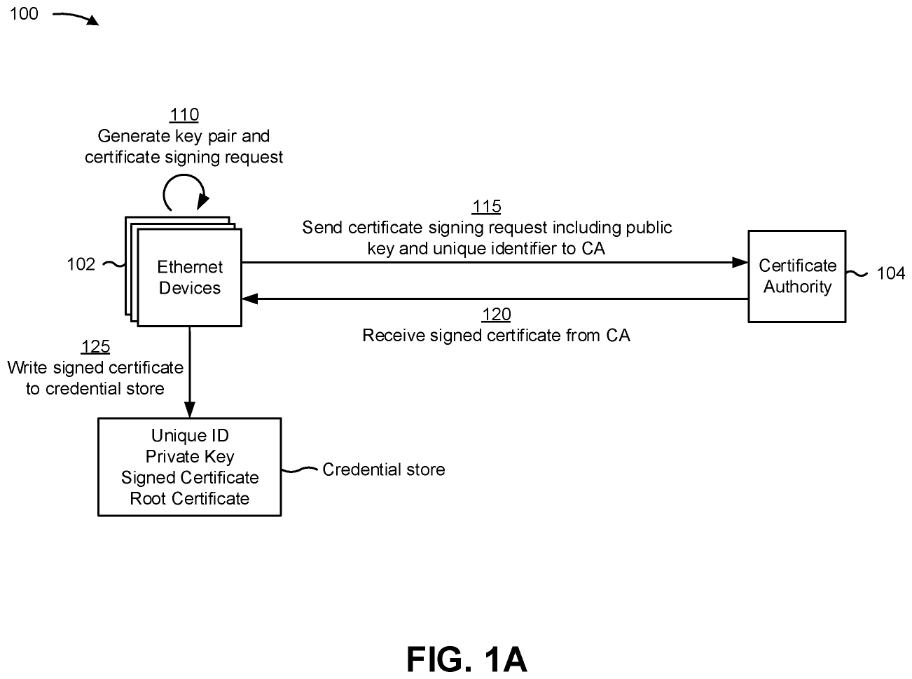

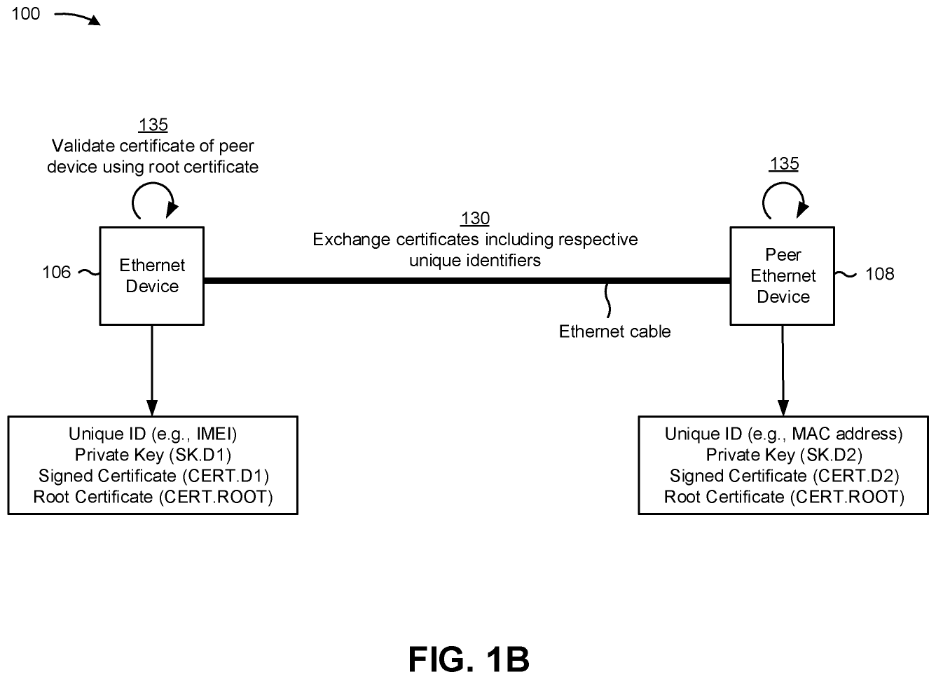

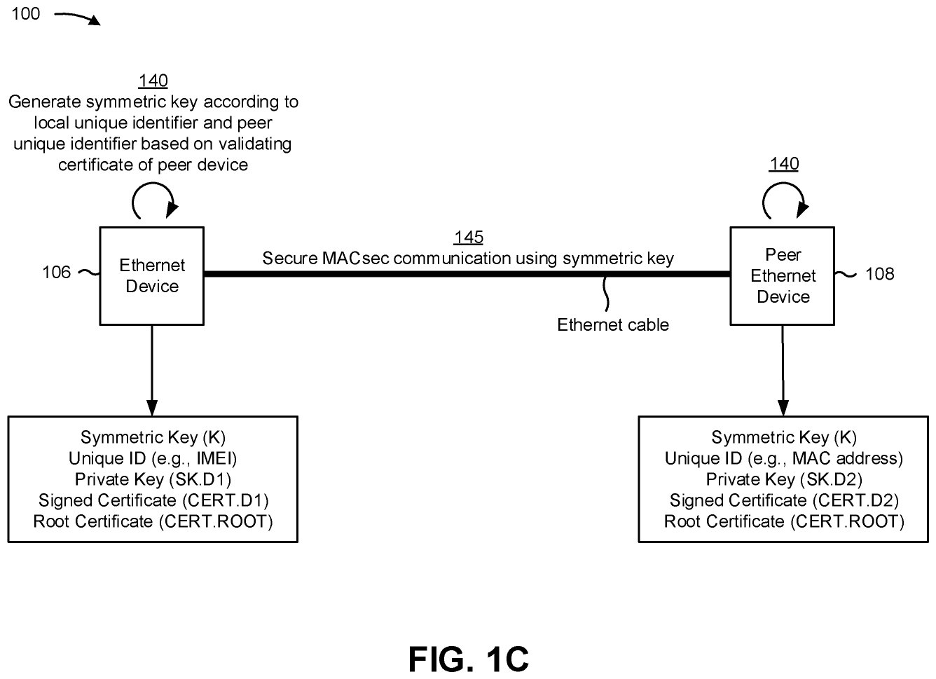

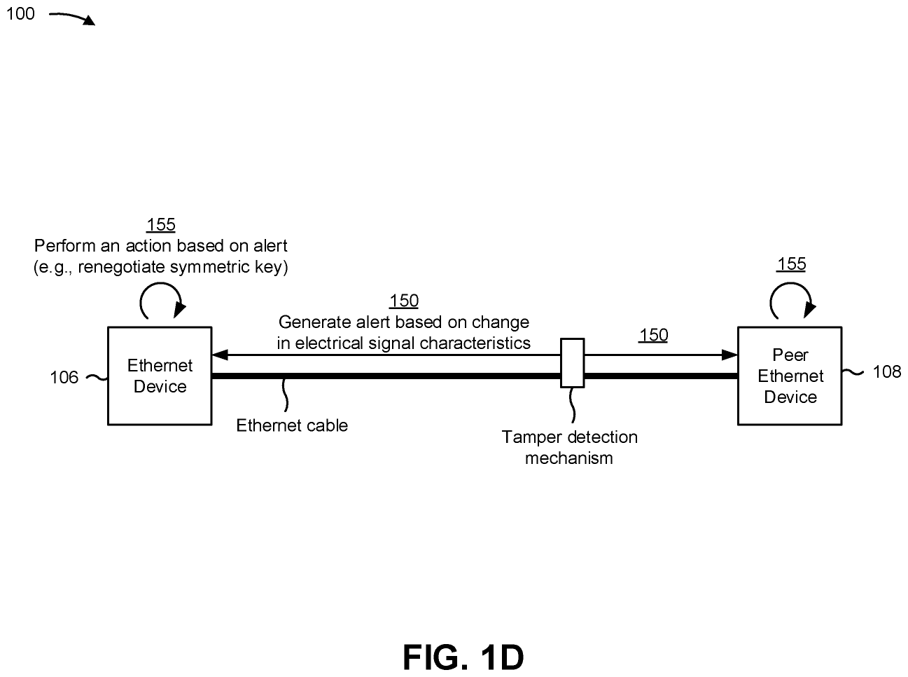

FIGS. 1A-1D are diagrams of one or more example implementations 100 described herein. As shown in FIG. 1A, example implementation(s) 100 may include a set of Ethernet devices 102 having MACsec communication capabilities, and a certificate authority 104 that may generate, issue, distribute, or otherwise manage digital certificates for the set of Ethernet devices 102. Furthermore, as shown in FIGS. 1B-1D, example implementation(s) 100 may include a pair of Ethernet devices 106, 108 that may use respective digital certificates obtained from the certificate authority 104 to establish a MACsec-secured point-to-point Ethernet link.

For example, as shown in FIG. 1A, an Ethernet device 102 may obtain, from the certificate authority 104, a signed digital certificate based on a certificate signing request that includes a unique identifier associated with the Ethernet device 102 and a public key associated with a key pair generated at the Ethernet device 102. As shown in FIG. 1B, in order to secure a point-to-point link between a pair of Ethernet devices 106, 108 using a MACsec protocol, the pair of Ethernet devices 106, 108 may exchange and validate respective digital certificates issued by the certificate authority 104. As shown in FIG. 1C, based on validating the digital certificates, the pair of Ethernet devices 106, 108 may independently generate a symmetric key that can be used to secure the point-to-point Ethernet link based on a local unique identifier in combination with a unique identifier associated with the other device, which may be read, extracted, or otherwise obtained from the previously exchanged digital certificate. As shown in FIG. 1D, a tamper detection mechanism may be used to monitor a physical wire (e.g., an Ethernet cable) connecting the pair of Ethernet devices 106, 108 and alert the Ethernet devices 106, 108 to perform an action (e.g., renegotiate the symmetric key) based on electrical signal characteristics on the physical wire (e.g., a change or a fluctuation in impedance that satisfies a condition).

As shown in FIG. 1A, and by reference number 110, a particular Ethernet device 102 may use a suitable algorithm (e.g., Rivest-Shamir-Adleman (RSA), Elliptic-curve cryptography (ECC), Digital Signature Algorithm (DSA), and/or the like) to generate an asymmetric key pair that includes a private key (sometimes called a “secret key”) and a corresponding public key. The public key generated by the Ethernet device 102 can be distributed to third parties without compromising security provided that the private key is kept secret (e.g., not exposed outside the Ethernet device 102 that generated the key pair, a secure device that provisioned the Ethernet device 102 with the key pair, and/or the like). In general, the public key can be used to encrypt a message sent to the Ethernet device 102, and the encrypted message can be decrypted only with the corresponding private key. Additionally, or alternatively, the Ethernet device 102 can use the private key to create a digital signature on a message transmitted by the Ethernet device 102, and another device receiving the message can use the public key to verify that the message was sent by the Ethernet device 102 asserting ownership of the public key and to verify that the message was not modified during transit.

In some implementations, the Ethernet device 102 may maintain the private key in a credential store, which may include a secure storage container to hold security data such as a unique identifier associated with the Ethernet device 102, the private key, username and password combinations, and/or the like. For example, the unique identifier may be an International Mobile Equipment Identity (IMEI) used to identify the Ethernet device 102 on a wireless wide area network (WWAN) (e.g., a 4G or 5G wireless network), a media access control (MAC) address assigned to a network interface controller (NIC) associated with the Ethernet device 102, a manufacturer-provided serial number associated with the Ethernet device 102, a universally unique identifier (UUID) generated according to Internet Engineering Task Force (IETF) methods, and/or the like.

As further shown in FIG. 1A, and by reference number 115, the Ethernet device 102 may send a certificate signing request (CSR) to the certificate authority 104 in order to apply for a digital certificate used to prove ownership of the public key (e.g., the public key associated with the key pair generated by the Ethernet device 102). For example, the CSR may include the public key generated by the Ethernet device 102, the unique identifier(s) associated with the Ethernet device 102, and a digital signature created using the private key (e.g., to ensure that another entity cannot fraudulently request a digital certificate using the public key belonging to the Ethernet device 102). As further shown in FIG. 1A, and by reference number 120, the Ethernet device 102 may receive a signed digital certificate from the certificate authority 104 based on the certificate authority 104 validating the information contained in the CSR (e.g., based on the digital signature). In some implementations, the certificate authority 104 may sign the digital certificate using a private key associated with the certificate authority 104.

In some implementations, the signed digital certificate received from the certificate authority 104 may include various fields such as a serial number that the certificate authority 104 has assigned to the digital certificate, a signature algorithm identifying a cryptographic algorithm that the certificate authority 104 used to sign the digital certificate, an identifier for the certificate authority 104, a date and/or time when the digital certificate becomes valid, a date and/or time when the digital certificate expires, information about the Ethernet device 102 to which the digital certificate was issued (e.g., the one or more unique identifiers associated with the Ethernet device 102), the public key that the Ethernet device 102 provided with the CSR, and/or the like. In some implementations, the certificate authority 104 may further support revocation with respect to the digital certificate. For example, the certificate authority 104 may revoke the digital certificate upon later determining that the digital certificate was improperly issued, discovered to be counterfeit, associated with a compromised (e.g., lost or stolen) private key, issued by a compromised subordinate certificate authority, based on the Ethernet device 102 failing to adhere to one or more policies, and/or the like. Accordingly, when the certificate authority 104 revokes one or more digital certificates, information related to the revoked digital certificate(s) can be made available through a certificate revocation list (CRL), an Online Certificate Status Protocol (OCSP), and/or the like.

In some implementations, communication that occurs between the Ethernet device 102 and the certificate authority 104 to request and obtain the digital certificate may be performed using one or more certificate enrollment procedures (e.g., at a time of manufacture, on-demand at a time of deployment at a customer premises, and/or the like). For example, in some implementations, the Ethernet device 102 may obtain the digital certificate from the certificate authority 104 based on the Simple Certificate Enrollment Protocol (SCEP), which provides procedures to securely issue digital certificates to network devices using HyperText Transfer Protocol (HTTP). Additionally, or alternatively, the digital certificate may be obtained using another suitable certificate enrollment protocol, such as Certificate Management Protocol, Certificate Management over Cryptographic Message Syntax (CMS), and/or the like. Additionally, or alternatively, the certificate enrollment process may be coordinated by a manufacturer of the Ethernet device 102. For example, the manufacturer may perform the certificate enrollment process at a manufacturing facility using one or more secure computing devices that communicate with the certificate authority 104 using one or more REpresentational State Transfer (REST) application program interfaces provided by the certificate authority 104.

As further shown in FIG. 1A, and by reference number 125, the Ethernet device 102 may write the signed digital certificate and a root certificate associated with the certificate authority 104 to the credential store. In some implementations, the certificate authority 104 may provide the root certificate to the Ethernet device 102 together with the signed digital certificate. Additionally, or alternatively, the Ethernet device 102 may use information such as the identifier for the certificate authority 104 (e.g., as provided in the signed digital certificate) to obtain the root certificate. As described in further detail elsewhere herein, the information contained in the credential store (e.g., the unique identifier(s) associated with the Ethernet device 102, the private key belonging to the Ethernet device 102, the signed digital certificate received from the certificate authority 104, the root certificate associated with the certificate authority 104, and/or the like) may be used when the Ethernet device 102 subsequently performs a handshake procedure to negotiate a symmetric key to be used to establish a secure point-to-point Ethernet link with a peer Ethernet device according to a MACsec protocol (e.g., the MACsec Key Agreement (MKA) protocol).

More particularly, as shown in FIG. 1B, and by reference number 130, an Ethernet device 106 may exchange, with a peer Ethernet device 108, digital certificates that include the respective unique identifiers associated with each device. For example, in some implementations, the Ethernet devices 106, 108 may perform the certificate exchange as part of the handshake procedure to negotiate the symmetric key when the Ethernet devices 106, 108 are connected via an Ethernet cable and powered on. At this point, the Ethernet devices 106, 108 may be in an unsecured (e.g., unauthenticated) state, and the handshake procedure may be performed to negotiate the symmetric key that enables the Ethernet devices 106, 108 to enter a MACsec-secured (e.g., authenticated) state.

For example, in some implementations, the digital certificate (CERT.D1) that the Ethernet device 106 provides to the peer Ethernet device 108 may include the unique identifier associated with the Ethernet device 106 (e.g., an IMEI). In a similar respect, the digital certificate (CERT.D2) that the Ethernet device 106 receives from the peer Ethernet device 108 may include a unique identifier associated with the peer Ethernet device 108 (e.g., a MAC address). Additionally, or alternatively, the unique identifiers may include other suitable identifiers, such as a serial number, a UUID, and/or the like. Furthermore, in some implementations, the digital certificates exchanged between the Ethernet devices 106, 108 may include other information such as the respective public keys owned by the Ethernet devices 106, 108, which the Ethernet devices 106, 108 can use to encrypt data sent to one another, to validate digital signatures associated with messages received from one another, and/or the like.

As further shown in FIG. 1B, and by reference number 135, each of the Ethernet devices 106, 108 may validate the digital certificate received from the other device. For example, the certificate authority 104 may issue digital certificates according to a certificate chain or hierarchical tree structure in which the root certificate is a top-most certificate and the private key of the certificate authority 104 is used to sign other certificates. Furthermore, in some cases, the certificate authority 104 may create one or more intermediate or subordinate certificate authorities to issue or otherwise distribute digital certificates. In this way, the certificate authority 104 may be a root certificate authority that can revoke an intermediate or subordinate certificate authority that has been compromised for any reason. Furthermore, the certificate authority 104 can additionally, or alternatively, create one or more new intermediate or subordinate certificate authorities to issue or otherwise distribute digital certificates, thus improving security. Furthermore, in this way, all certificates in the certificate chain inherit the trustworthiness of the root certificate.

Accordingly, in some implementations, the Ethernet devices 106, 108 may validate the digital certificates received from one another by tracing the certificate chain, which can have a hierarchical tree structure in which the root certificate represents a trusted anchor for other certificates. In particular, as mentioned elsewhere herein, the certificate authority 104 can use its private key to self-sign the root certificate and also use its private key to sign certificates associated with one or more subordinate certificate authorities. The one or more subordinate certificate authorities can use their private keys to sign certificates that the subordinate certificate authorities may issue. In this way, the certificate chain can include a sequence of certificates in which each certificate can be signed using the private key of its issuer, thus producing a sequence of digital signatures that can be verified to determine whether the certificate was created by a known entity (e.g., the certificate authority 104).

For example, in some implementations, each digital signature in the sequence of digital signatures can be verified using the public key in the certificate associated with the issuer, which is the next certificate in the chain. In this way, the certificate chain can trace a path from a given certificate to the root in the hierarchical tree structure. Accordingly, when the Ethernet device 106 validates the digital certificate received from the peer Ethernet device 108 (and vice versa), the Ethernet device 106 can attempt to trace the path of the certificate issued to the peer Ethernet device 108 to verify that the digital certificate issued to the peer Ethernet device 108 leads to the root certificate. In this way, the Ethernet devices 106, 108 can mutually verify that the other device has a digital certificate that inherits the trustworthiness of the root certificate belonging to the certificate authority 104.

Furthermore, in some implementations, each of the Ethernet devices 106, 108 may validate that the digital certificate received from the other device is not revoked, expired, or otherwise invalid. For example, as mentioned above, a given digital certificate may include information such as a date and/or time when the digital certificate becomes valid, a date and/or time when the digital certificate expires, and/or the like. Accordingly, when the Ethernet device 106 validates the digital certificate received from the peer Ethernet device 108 (and vice versa), the Ethernet device 106 may verify that a current date and/or time falls within a validity period for the digital certificate (e.g., the current date and/or time is after the date and/or time when the digital certificate becomes valid and earlier than the date and/or time when the digital certificate expires). Furthermore, the Ethernet device 106 verify that the digital certificate received from the peer Ethernet device 108 does not appear in a certificate revocation list (CRL). Accordingly, the Ethernet device 106 may validate the digital certificate received from the peer Ethernet device 108 based on determining that the digital certificate was signed by the certificate authority 104 or a trusted subordinate of the certificate authority 104 and that the digital certificate is not revoked, expired, or otherwise invalid.

As shown in FIG. 1C, and by reference number 140, the pair of Ethernet devices 106, 108 may each independently generate the symmetric key according to a local unique identifier and a peer unique identifier based on validating the digital certificate of the other device. For example, to generate the symmetric key, the Ethernet device 106 may read, extract, or otherwise obtain the unique identifier of the peer Ethernet device 108 from the validated digital certificate. Accordingly, the unique identifier of the Ethernet device 106 and the unique identifier of the peer Ethernet device 108 may be used as inputs to a key generation algorithm that outputs the symmetric key. For example, in some implementations, the key generation algorithm may be a cryptographic hash function, such as a hash function based on Secure Hash Algorithm 2 (SHA-2) (e.g., SHA-256, SHA-512, and/or the like). In this way, because both Ethernet devices 106, 108 use the same inputs (e.g., the local unique identifier, and the peer unique identifier) and the same key generation algorithm to generate the symmetric key, the symmetric key can be used as a shared secret to establish a secure connection over the Ethernet cable using MACsec. In this way, the handshake procedure used to negotiate the symmetric key may avoid a need to manually or dynamically provision the symmetric key, since the Ethernet devices 106, 108 instead self-generate the symmetric key based on information contained in the exchanged digital certificates. In this way, enabling the Ethernet devices 106, 108 to self-generate the symmetric key may reduce network overhead, computing resource consumption, and/or the like that would otherwise occur through manually and/or dynamically provisioning the symmetric key.

In some implementations, the Ethernet devices 106, 108 may coordinate one or more random numbers and/or other variables to be used as inputs to the key generation algorithm. Otherwise, a potential attacker knowing the unique identifiers of both Ethernet devices 106, 108 may potentially generate the symmetric key and implement a man-in-the-middle attack, a masquerading attack, and/or another security breach. Accordingly, the one or more random numbers and/or other variables may be determined based on a particular scheme that is synchronized or otherwise coordinated between the Ethernet devices 106, 108 to enhance security by making the symmetric key a unique single-use shared secret. For example, the one or more random numbers may include a cryptographic salt, which refers to random data (e.g., an alphanumeric string) generated according to a scheme that ensures that the cryptographic salt is globally unique. For example, the cryptographic salt may be a random number that has a sufficient length and/or entropy that makes a salt collision cryptographically unlikely.

In some implementations, when the cryptographic salt (and/or other variables) is used as additional inputs to the key generation algorithm, the cryptographic salt may be combined (e.g., concatenated) with the unique identifiers for the Ethernet devices 106, 108 and input to the key generation algorithm. Additionally, or alternatively, a key derivation function such as a Password-Based Key Derivation Function (PBKDF) may be used, whereby a pseudorandom function such as a hash-based message authentication code (HMAC) is applied to a string that combines the unique identifiers for the Ethernet devices 106, 108 with the cryptographic salt one or more times to derive the symmetric key.

As mentioned elsewhere herein, the cryptographic salt and/or other variables used to randomize the symmetric key may be coordinated between the Ethernet devices 106, 108 to ensure that both Ethernet devices 106, 108 use the same input(s) to generate the symmetric key. For example, in some implementations, one device (e.g., Ethernet device 106) may determine the cryptographic salt to be used and encrypt the cryptographic salt using the public key of the other device (e.g., the public key of the peer Ethernet device 108). The encrypted cryptographic salt can be communicated to the other device, which may decrypt the cryptographic salt using the private key contained in the credential store. Additionally, or alternatively, the encrypted data may be a seed used to initialize a pseudorandom number generator and/or the like that the Ethernet devices 106, 108 use to independently generate the cryptographic salt. Additionally, or alternatively, the Ethernet devices 106, 108 may include housings with physical buttons, interfaces to display virtual buttons, and/or the like, which may synchronize the Ethernet devices 106, 108 and/or trigger the handshake procedure described herein. Accordingly, when the button(s) are pressed on the Ethernet devices 106, 108, the cryptographic salt, seed value, local clocks, and/or the like may be synchronized between the Ethernet devices 106, 108 such that the Ethernet devices 106, 108 are able to independently generate the symmetric key based on the exchange of unique identifiers associated with the Ethernet devices 106, 108.

As further shown in FIG. 1C, and by reference number 145, the Ethernet devices 106, 108 may use the symmetric key generated in the manner described above to establish a secure communication session over the point-to-point Ethernet link. For example, the Ethernet devices 106, 108 may exchange the symmetric key with one another over the point-to-point Ethernet link and enable a MACsec Key Agreement (MKA) protocol upon each of the Ethernet devices 106, 108 verifying that the symmetric key provided by the other endpoint matches the locally generated symmetric key. In a similar manner as mentioned elsewhere herein, the MKA protocol may designate one of the Ethernet devices 106, 108 to act as a key server, which is responsible for creating a randomly-generated secure association key (SAK) to secure data plane traffic over the point-to-point Ethernet link. The endpoint acting as the key server may share the SAK with the other endpoint, and the SAK may be used to secure data traffic that traverses the point-to-point Ethernet link. The key server may continue to periodically create and share a randomly-generated SAK over the point-to-point Ethernet link while MACsec is enabled.

As shown in FIG. 1D, and by reference number 150, a tamper detection mechanism may be used to monitor electrical signal characteristics on the Ethernet cable connecting the pair of Ethernet devices 106, 108 to detect conditions that may indicate potential tampering (e.g., eavesdropping, snooping, an injection attack, and/or the like) with the point-to-point Ethernet link. For example, during the handshake procedure in which the Ethernet devices 106, 108 negotiate the symmetric key, the tamper detection mechanism may monitor electrical signal characteristics on the Ethernet cable connecting the pair of Ethernet devices 106, 108 and use the monitored electrical signal characteristics to establish one or more baseline parameters (e.g., an average impedance, a range of impedance, and/or the like measured during the negotiation). Accordingly, the tamper detection mechanism may generate an alert that is communicated to Ethernet devices 106, 108 based on a change or fluctuation in electrical characteristics satisfying a condition (e.g., a peak impedance, an average impedance, and/or the like satisfying a threshold, having a value outside the range established in the baseline parameters, and/or the like).

As further shown in FIG. 1D, and by reference number 155, the Ethernet devices 106, 108 may perform an action based on the alert. For example, in some implementations, the action may include renegotiating the symmetric key to mitigate a potential attack whereby an unauthorized user or device may have gained access to the data communicated over the MACsec-secured point-to-point Ethernet link. In another example, the action may include displaying an alert, generating an audible alert, and/or the like to recommend that users, administrators, or other operators of the Ethernet devices 106, 108 check the Ethernet cable to ensure that there has not been any tampering, to verify that the Ethernet cable has not been damaged, to verify that the Ethernet cable is correctly seated in an Ethernet port, and/or the like. In some implementations, the users, administrators, or other operators may be given an option to dismiss the alert (e.g., where the change or fluctuation in electrical characteristics was a result of a brief power surge or power outage, after replacing a damaged Ethernet cable, and/or the like).

As indicated above, FIGS. 1A-1D are provided as one or more examples. Other examples can differ from what is described with regard to FIGS. 1A-1D.

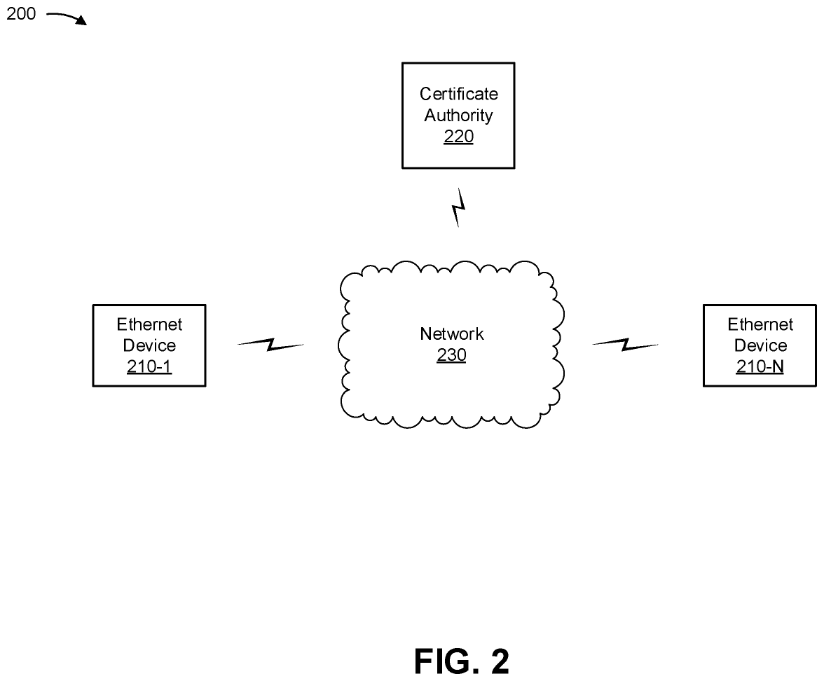

FIG. 2 is a diagram of an example environment 200 in which systems and/or methods described herein may be implemented. As shown in FIG. 2, environment 200 may include one or more Ethernet devices 210-1 through 210-N (N≥2) (hereinafter referred to collectively as “Ethernet devices 210,” and individually as “Ethernet device 210”), a certificate authority 220, and a network 230. Devices of environment 200 may interconnect via wired connections, wireless connections, or a combination of wired and wireless connections.

Ethernet devices 210 include one or more devices that have a wired Ethernet interface and capabilities to receive and/or provide information over a network (e.g., network 230), capabilities to generate, store, and/or process information received and/or provided over the network, and/or the like. For example, Ethernet devices 210 may include one or more traffic transfer devices, such as a modem that can deliver wired and/or wireless broadband access to a wide area network (WAN) at a customer premises, a router that may connect to the modem via a wireless and/or wired Ethernet connection, an extender that can connect to the router via a wireless and/or wired Ethernet connection and retransmit signals communicated by the router to extend WAN coverage at the customer premises, and/or the like. Additionally, or alternatively, the one or more traffic transfer devices may include a firewall, a gateway, a switch, a hub, a bridge, a reverse proxy, a server (e.g., a proxy server), a security device, an intrusion detection device, a load balancer, and/or the like. In another example, Ethernet devices 210 may include one or more host devices having an Ethernet interface, such as a desktop computer, a laptop computer, a tablet computer, a phone (e.g., a Voice over Internet Protocol (VoIP) phone), a media streaming device, and/or the like. Ethernet device 210 may act as an endpoint (e.g., a source and/or a destination) for a communication with another Ethernet device 210.

For example, a particular pair of Ethernet devices 210 may perform a certificate exchange over a point-to-point Ethernet link, where the certificate exchange involves each Ethernet device 210 providing the other Ethernet device 210 with a digital certificate obtained from certificate authority 220. The exchanged digital certificates may include respective unique identifiers associated with the particular pair of Ethernet devices 210, which may be used to generate a symmetric key using a key generation algorithm. Accordingly, the particular pair of Ethernet devices 210 may use the symmetric key to establish a secure communication session over the point-to-point Ethernet link.

Certificate authority 220 includes one or more devices capable of managing (e.g., receiving, generating, storing, processing, and/or providing) information associated with digital certificates that Ethernet devices 210 use to independently generate a symmetric key to implement a Media Access Control security (MACsec) check. In some implementations, certificate authority 220 may issue digital certificates to Ethernet devices 210 according to a Simple Certificate Enrollment Protocol (SCEP), via communicating with one or more devices at a manufacturing facility associated with Ethernet devices 210 using an application program interface (e.g., a REpresentational State Transfer (REST) application program interface), and/or the like. For example, certificate authority 220 may issue digital certificates to Ethernet devices 210 based on certificate signing requests received from Ethernet devices 210 and/or other devices that can provision the digital certificates onto Ethernet devices 210. Accordingly, Ethernet devices 210 can exchange the digital certificates to establish a trust relationship (e.g., by tracing a chain of trust to a root certificate associated with certificate authority 220) and convey respective unique identifiers (e.g., IMEIs, MAC addresses, serial numbers, and/or the like), which Ethernet devices 210 may use to independently generate the symmetric key.

Network 230 includes one or more wired and/or wireless networks. For example, network 230 may include a cellular network (e.g., a long-term evolution (LTE) network, a code division multiple access (CDMA) network, a 3G network, a 4G network, a 5G network, another type of next generation network, and/or the like), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, a core network, and/or the like, and/or a combination of these or other types of networks.

The number and arrangement of devices and networks shown in FIG. 2 are provided as one or more examples. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

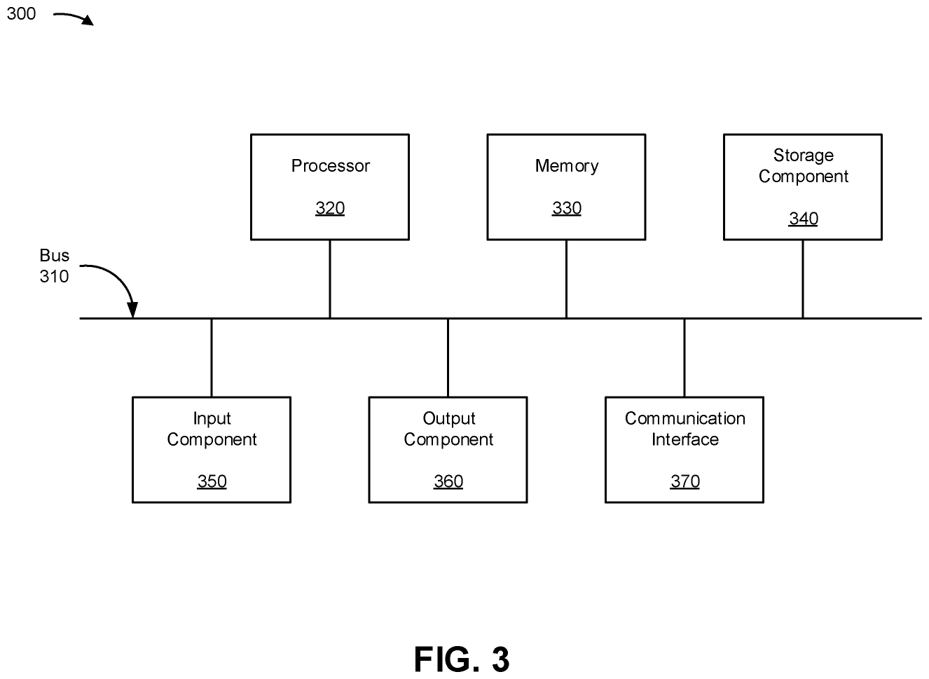

FIG. 3 is a diagram of example components of a device 300. Device 300 may correspond to Ethernet device(s) 210 and/or certificate authority 220. In some implementations, Ethernet device(s) 210 and/or certificate authority 220 may include one or more devices 300 and/or one or more components of device 300. As shown in FIG. 3, device 300 may include a bus 310, a processor 320, a memory 330, a storage component 340, an input component 350, an output component 360, and a communication interface 370.

Bus 310 includes a component that permits communication among multiple components of device 300. Processor 320 is implemented in hardware, firmware, and/or a combination of hardware and software. Processor 320 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 320 includes one or more processors capable of being programmed to perform a function. Memory 330 includes a random-access memory (RAM), a read only memory (ROM), and/or another type of dynamic or static storage device (e.g., a flash memory, a magnetic memory, and/or an optical memory) that stores information and/or instructions for use by processor 320.

Storage component 340 stores information and/or software related to the operation and use of device 300. For example, storage component 340 may include a hard disk (e.g., a magnetic disk, an optical disk, and/or a magneto-optic disk), a solid-state drive (SSD), a compact disc (CD), a digital versatile disc (DVD), a floppy disk, a cartridge, a magnetic tape, and/or another type of non-transitory computer-readable medium, along with a corresponding drive.

Input component 350 includes a component that permits device 300 to receive information, such as via user input (e.g., a touch screen display, a keyboard, a keypad, a mouse, a button, a switch, and/or a microphone). Additionally, or alternatively, input component 350 may include a component for determining location (e.g., a global positioning system (GPS) component) and/or a sensor (e.g., an accelerometer, a gyroscope, an actuator, another type of positional or environmental sensor, and/or the like). Output component 360 includes a component that provides output information from device 300 (via, e.g., a display, a speaker, a haptic feedback component, an audio or visual indicator, and/or the like).

Communication interface 370 includes a transceiver-like component (e.g., a transceiver, a separate receiver, a separate transmitter, and/or the like) that enables device 300 to communicate with other devices, such as via a wired connection, a wireless connection, or a combination of wired and wireless connections. Communication interface 370 may permit device 300 to receive information from another device and/or provide information to another device. For example, communication interface 370 may include an Ethernet interface, an optical interface, a coaxial interface, an infrared interface, a radio frequency (RF) interface, a universal serial bus (USB) interface, a wireless local area network interface, a cellular network interface, and/or the like.

Device 300 may perform one or more processes described herein. Device 300 may perform these processes based on processor 320 executing software instructions stored by a non-transitory computer-readable medium, such as memory 330 and/or storage component 340. As used herein, the term “computer-readable medium” refers to a non-transitory memory device. A memory device includes memory space within a single physical storage device or memory space spread across multiple physical storage devices.

Software instructions may be read into memory 330 and/or storage component 340 from another computer-readable medium or from another device via communication interface 370. When executed, software instructions stored in memory 330 and/or storage component 340 may cause processor 320 to perform one or more processes described herein. Additionally, or alternatively, hardware circuitry may be used in place of or in combination with software instructions to perform one or more processes described herein. Thus, implementations described herein are not limited to any specific combination of hardware circuitry and software.

The number and arrangement of components shown in FIG. 3 are provided as an example. In practice, device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

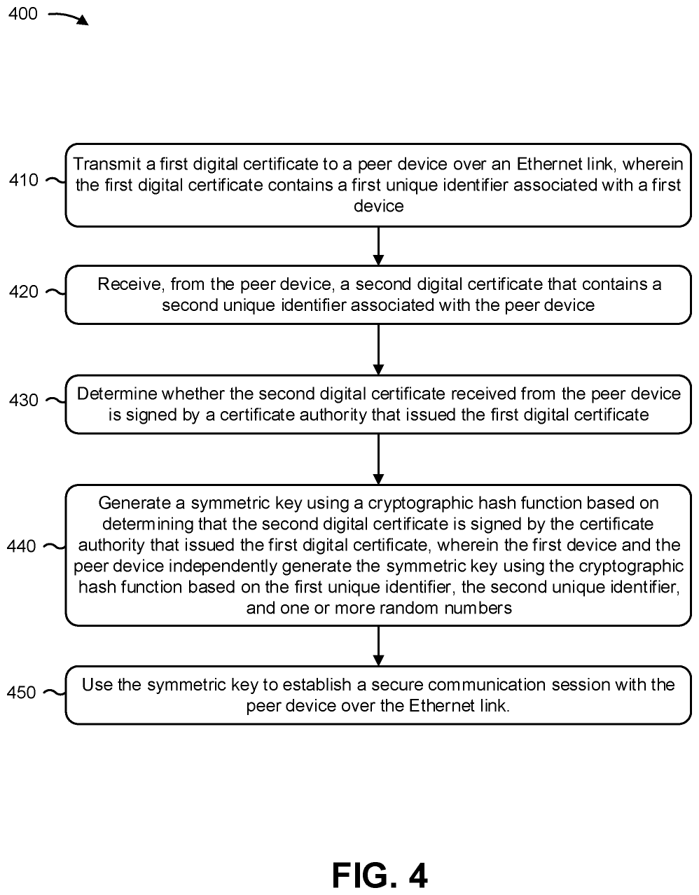

FIG. 4 is a flow chart of an example process 400 for generating a symmetric key to implement a Media Access Control security (MACsec) check. In some implementations, one or more process blocks of FIG. 4 may be performed by an Ethernet device (e.g., one or more of Ethernet devices 210). In some implementations, one or more process blocks of FIG. 4 may be performed by another device or a group of devices separate from or including the Ethernet device, such as a certificate authority (e.g., certificate authority 220, and/or the like.

As shown in FIG. 4, process 400 may include transmitting a first digital certificate to a peer device over an Ethernet link, wherein the first digital certificate contains a first unique identifier associated with a first device (e.g., the Ethernet device) (block 410). For example, the Ethernet device (e.g., using processor 320, memory 330, storage component 340, input component 350, output component 360, communication interface 370, and/or the like) may transmit a first digital certificate to a peer device over an Ethernet link, as described above. In some implementations, the first digital certificate contains a first unique identifier associated with the first device, and the first device may obtain the first digital certificate from a certificate authority by communicating with the certificate authority according to a Simple Certificate Enrollment Protocol (SCEP), an application program interface provided by the certificate authority, and/or the like. For example, to obtain the first digital certificate, the first device may generate a cryptographic key pair that includes a public key for encrypting data and a private key for decrypting data that is encrypted using the public key, transmit a certificate signing request that includes the public key and the first unique identifier associated with the first device to the certificate authority, and receive the first digital certificate from the certificate authority based on the certificate signing request.

As further shown in FIG. 4, process 400 may include receiving, from the peer device, a second digital certificate that contains a second unique identifier associated with the peer device (block 420). For example, the Ethernet device (e.g., using processor 320, memory 330, storage component 340, input component 350, output component 360, communication interface 370, and/or the like) may receive, from the peer device, a second digital certificate that contains a second unique identifier associated with the peer device, as described above.

In some implementations, the first device and the peer device may perform a handshake to exchange the first digital certificate and the second digital certificate based on a trigger event. For example, the first device and/or the peer device may include a button that causes the first device and the peer device to perform the handshake in order to negotiate a symmetric key when the button is pressed. Additionally, or alternatively, the first device may receive an alert indicating potential unauthorized tampering with the Ethernet link based on one or more electrical signal characteristics associated with a physical wire (e.g., an Ethernet cable) connecting the first device and the peer device, and the first device and the peer device may perform the handshake to renegotiate the symmetric key based on the alert. For example, the one or more electrical signal characteristics that indicate the potential unauthorized tampering may include a change or a fluctuation in impedance that satisfies a condition.

As further shown in FIG. 4, process 400 may include determining whether the second digital certificate received from the peer device is signed by a certificate authority that issued the first digital certificate (block 430). For example, the Ethernet device (e.g., using processor 320, memory 330, storage component 340, input component 350, output component 360, communication interface 370, and/or the like) may determine whether the second digital certificate received from the peer device is signed by a certificate authority that issued the first digital certificate, as described above. For example, the Ethernet device may obtain a root certificate associated with the certificate authority and determine whether the second digital certificate is signed by the certificate authority based on whether a chain of trust can be traced from the second digital certificate to the root certificate.

As further shown in FIG. 4, process 400 may include generating a symmetric key using a cryptographic hash function based on determining that the second digital certificate is signed by the certificate authority that issued the first digital certificate, wherein the first device and the peer device independently generate the symmetric key using the cryptographic hash function based on the first unique identifier, the second unique identifier, and one or more random numbers (block 440). For example, the Ethernet device (e.g., using processor 320, memory 330, storage component 340, input component 350, output component 360, communication interface 370, and/or the like) may generate a symmetric key using a cryptographic hash function based on determining that the second digital certificate is signed by the certificate authority that issued the first digital certificate, as described above. In some implementations, the first device and the peer device independently generate the symmetric key using the cryptographic hash function based on the first unique identifier, the second unique identifier, and one or more random numbers (e.g., a cryptographic salt that the first device and the peer device independently generate according to a particular scheme).

As further shown in FIG. 4, process 400 may include using the symmetric key to establish a secure communication session with the peer device over the Ethernet link (block 450). For example, the Ethernet device (e.g., using processor 320, memory 330, storage component 340, input component 350, output component 360, communication interface 370, and/or the like) may use the symmetric key to establish a secure communication session with the peer device over the Ethernet link, as described above. For example, the secure communication session may be established according to a MACsec protocol.

Process 400 may include additional implementations, such as any single implementation or any combination of implementations described in connection with one or more other processes described elsewhere herein.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

The foregoing disclosure provides illustration and description, but is not intended to be exhaustive or to limit the implementations to the precise form disclosed. Modifications and variations may be made in light of the above disclosure or may be acquired from practice of the implementations.

As used herein, the term “component” is intended to be broadly construed as hardware, firmware, or a combination of hardware and software.

As used herein, satisfying a threshold may, depending on the context, refer to a value being greater than the threshold, more than the threshold, higher than the threshold, greater than or equal to the threshold, less than the threshold, fewer than the threshold, lower than the threshold, less than or equal to the threshold, equal to the threshold, and/or the like, depending on the context.

Certain user interfaces have been described herein and/or shown in the figures. A user interface may include a graphical user interface, a non-graphical user interface, a text-based user interface, and/or the like. A user interface may provide information for display. In some implementations, a user may interact with the information, such as by providing input via an input component of a device that provides the user interface for display. In some implementations, a user interface may be configurable by a device and/or a user (e.g., a user may change the size of the user interface, information provided via the user interface, a position of information provided via the user interface, and/or the like). Additionally, or alternatively, a user interface may be pre-configured to a standard configuration, a specific configuration based on a type of device on which the user interface is displayed, and/or a set of configurations based on capabilities and/or specifications associated with a device on which the user interface is displayed.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method, comprising:
performing, by a first device, a certificate exchange with a peer device connected to the first device over an Ethernet link, wherein performing the certificate exchange includes:
transmitting, to the peer device, a first digital certificate that contains a first unique identifier associated with the first device, and
receiving, from the peer device, a second digital certificate that contains a second unique identifier associated with the peer device;
obtaining, by the first device, the second unique identifier from the second digital certificate received from the peer device based on validating that the second digital certificate is signed by a certificate authority that signed the first digital certificate;
generating, by the first device, a symmetric key using a key generation algorithm based on the first unique identifier and the second unique identifier; and
using, by the first device, the symmetric key to establish a secure communication session with the peer device over the Ethernet link.

2. The method of claim 1, wherein the secure communication session is established according to a Media Access Control security (MACsec) protocol.

3. The method of claim 1, wherein:
the key generation algorithm is a cryptographic hash function,
inputs to the cryptographic hash function include the first unique identifier and the second unique identifier, and
the symmetric key is an output of the cryptographic hash function.

4. The method of claim 3, wherein the inputs to the cryptographic hash function further include a cryptographic salt that the first device and the peer device independently generate according to a particular scheme.

5. The method of claim 1, further comprising:
obtaining the first digital certificate from the certificate authority by communicating with the certificate authority according to one or more of a Simple Certificate Enrollment Protocol (SCEP) or an application program interface provided by the certificate authority.

6. The method of claim 1, further comprising:
generating a cryptographic key pair that includes a public key for encrypting data and a private key for decrypting data that is encrypted using the public key;
transmitting, to the certificate authority, a certificate signing request that includes the public key and the first unique identifier associated with the first device; and
receiving the first digital certificate from the certificate authority based on the certificate signing request.

7. The method of claim 1, further comprising:
obtaining a root certificate associated with the certificate authority; and
validating that the second digital certificate is signed by the certificate authority based on tracing a certificate chain of trust from the second digital certificate to the root certificate.

8. The method of claim 1, further comprising:
receiving an alert indicating potential unauthorized tampering with the Ethernet link based on one or more electrical signal characteristics associated with a physical wire connecting the first device and the peer device; and
renegotiating the symmetric key with the peer device based on the alert.

9. A device, comprising:
one or more memories; and
one or more processors, communicatively coupled to the one or more memories, to:
transmit, to a peer device connected to the device over an Ethernet link, a first digital certificate that contains a first unique identifier associated with the device;
receive, from the peer device, a second digital certificate that contains a second unique identifier associated with the peer device;
generate a symmetric key using a key generation algorithm based on the first unique identifier and the second unique identifier;
use the symmetric key to establish a secure communication session with the peer device over the Ethernet link;
receive an alert indicating potential unauthorized tampering with the Ethernet link based on one or more electrical signal characteristics associated with a physical wire connecting the device and the peer device; and
renegotiate the symmetric key with the peer device based on the alert.

10. The device of claim 9, wherein the one or more electrical signal characteristics include one or more of a change or a fluctuation in impedance that satisfies a condition.

11. The device of claim 9, wherein the secure communication session is established according to a Media Access Control security (MACsec) protocol.

12. The device of claim 9, wherein:
the key generation algorithm is a cryptographic hash function,
inputs to the cryptographic hash function include the first unique identifier, the second unique identifier, and a cryptographic salt that the device and the peer device independently generate according to a particular scheme, and
the symmetric key is an output of the cryptographic hash function.

13. The device of claim 9, wherein the one or more processors are further to:
obtain the first digital certificate from a certificate authority by communicating with the certificate authority according to one or more of a Simple Certificate Enrollment Protocol (SCEP) or an application program interface provided by the certificate authority.

14. The device of claim 9, wherein the one or more processors are further to:
transmit, to a certificate authority, a certificate signing request that includes the first unique identifier associated with the device and a public key associated with a cryptographic key pair generated by the device; and
receive the first digital certificate from the certificate authority based on the certificate signing request.

15. A non-transitory computer-readable medium storing instructions, the instructions comprising:
one or more instructions that, when executed by one or more processors of a first device, cause the one or more processors to:
transmit a first digital certificate to a peer device connected to the first device over an Ethernet link,
wherein the first digital certificate contains a first unique identifier associated with the first device;
receive, from the peer device, a second digital certificate that contains a second unique identifier associated with the peer device;
determine whether the second digital certificate received from the peer device is signed by a certificate authority that issued the first digital certificate to the first device;
generate a symmetric key using a cryptographic hash function based on determining that the second digital certificate is signed by the certificate authority that issued the first digital certificate to the first device,
wherein the first device and the peer device independently generate the symmetric key using the cryptographic hash function based on the first unique identifier, the second unique identifier, and one or more random numbers; and
use the symmetric key to establish a secure communication session with the peer device over the Ethernet link.

16. The non-transitory computer-readable medium of claim 15, wherein the secure communication session is established according to a Media Access Control security (MACsec) protocol.

17. The non-transitory computer-readable medium of claim 15, wherein the one or more random numbers include a cryptographic salt.

18. The non-transitory computer-readable medium of claim 15, wherein the one or more instructions, when executed by the one or more processors, further cause the one or more processors to:
obtain a root certificate associated with the certificate authority; and
determine that the certificate authority signed the second digital certificate based on tracing a certificate chain of trust from the second digital certificate to the root certificate.

19. The non-transitory computer-readable medium of claim 15, wherein the one or more instructions, when executed by the one or more processors, further cause the one or more processors to:
receive an alert indicating potential unauthorized tampering with the Ethernet link based on one or more electrical signal characteristics associated with a physical wire connecting the first device and the peer device; and
renegotiate the symmetric key with the peer device based on the alert.

20. The non-transitory computer-readable medium of claim 15, wherein the first device has a button that causes the first device to perform a handshake to negotiate the symmetric key with the peer device when the button is pressed.
